(19) United States
(12) Patent Application Publication
(10) Pub. No.: US 2024/0257029 A1
(43) Pub. Date: Aug. 1, 2024

(54) DYNAMIC SINGLE ROUTE OPTIMIZATION AND TRAILER LOADING FEASBILITY CHECK

(71) Applicant: Walmart Apollo, LLC, Bentonville, AR (US)

(72) Inventors: Daniel Alberto Zuniga Vazquez, San Jose, CA (US); Ou Sun, Rancho Santa Margarita, CA (US); Ti Zhang, Rocklin, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/103,357

(22) Filed: Jan. 30, 2023

(51) Int. Cl. G06Q 10/08; G06Q 10/047; G06Q 10/067

(52) U.S. Cl. CPC G06Q 10/08; G06Q 10/047; G06Q 10/067

(57) ABSTRACT

A system comprising one or more processors and one or more non-transitory computer-readable media storing computing instructions, that when executed on the one or more processors, cause the one or more processors, to perform functions comprising: receiving, by an application programing interface (API), a change request for a route plan, wherein the change request is subject to a scenario specification and a load feasibility specification; determining an updated route plan based on whether the change request for the route plan is a feasible route based on the scenario specification and the load feasibility specification, and the route stop time is the route start time is flexible; and outputting the updated route plan and, when the route stop time is flexible, outputting the route start time. Other embodiments are disclosed.

### TECHNICAL FIELD

This disclosure relates generally to dynamic single route optimization and trailer loading feasibility check.

### BACKGROUND

Route plans and load plans are created to transport store orders to stores within a time period. Each change request to a single route plan can have a domino effect with multiple modifications to each route plan, each load plan, and each dock start time. Change requests can cause a feasible route plan to become infeasible. Creating a feasible solution using manual techniques can be inefficient and complicated in order to meet a promised date and time.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system for dynamically generating an updated route plan by incorporating a change request to a previous route plan, according to an embodiment;

FIG. 4 illustrates a flow chart for a method of automatically integrating stop changes on the route plan to add and/or remove stops using a dynamic single route optimization system, according to an embodiment;

FIG. 5 illustrates a flow chart for a method of generating an updated route plan based on each combination of input parameters and respective scenario specifications, according to an embodiment;

FIG. 6 illustrates a flow chart for a method of constructing an updated route plan and load plan, according to an embodiment;

FIG. 7 illustrates a flow chart for a method of constructing an updated route plan incorporating each constraint of a respective user specified sequence, according to an embodiment

FIG. 8 illustrates a timeline showing how a sequence of activities is created comprising multiple stop sequences in a single route plan; and

FIG. 9 illustrates a flow chart for a method of automatically generating an updated route plan based on a change request to the previous route plan, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus. The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

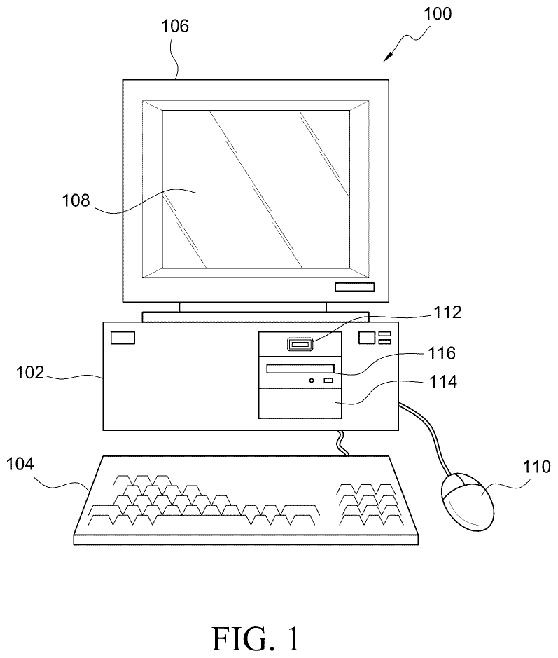

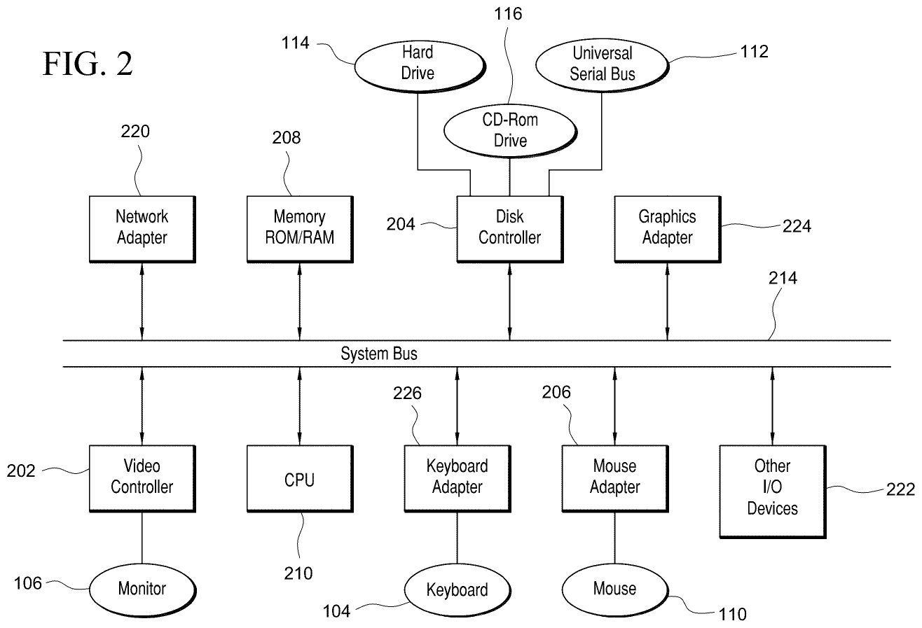

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network.

The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

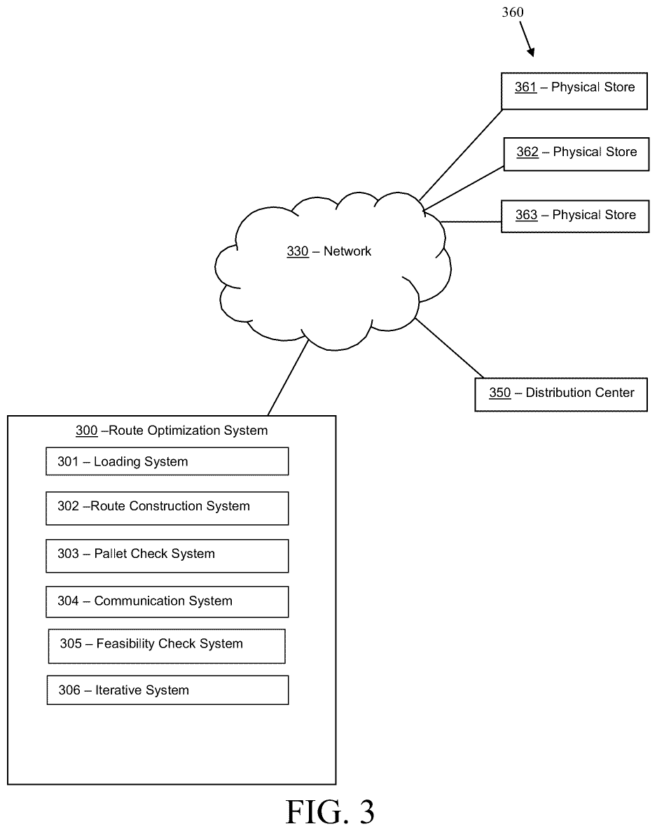

Turning ahead in the drawings, FIG. 3 illustrates a block diagram of a route optimization system 300 for dynamically generating an updated route plan by incorporating a change request to a previous route plan, according to an embodiment. Route optimization system 300 also can be employed for determining whether the updated route plan is in compliance with one or more constraints. Route optimization system 300 is merely exemplary and embodiments of the system are not limited to the embodiments presented herein. The route optimization system can be employed in many different embodiments or examples not specifically depicted or described herein. In some embodiments, certain elements, modules, or systems of route optimization system 300 can perform various procedures, processes, and/or activities. In other embodiments, the procedures, processes, and/or activities can be performed by other suitable elements, modules, or systems of route optimization system 300. Route optimization system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of route optimization system 300 described herein.

In many embodiments, route optimization system 300 can be a computer system, such as computer system 100 (FIG. 1), as described above, and can each be a single computer, a single server, or a cluster or collection of computers or servers, or a cloud of computers or servers. In another embodiment, a single computer system can host route optimization system 300. Additional details regarding route optimization system 300 are described herein.

In some embodiments, route optimization system 300 can be in data communication through a network 330 with physical stores 360, which can include physical stores 361-363, for example, and distribution centers, such as distribution center 350. In several embodiments, each of the physical stores (e.g., 360) and each of the distribution centers (e.g., 350) can be a physical, brick-and-mortar location that are associated (e.g., operated by a common business entity or entities under common control) with route optimization system 300. In many embodiments, the physical stores (e.g., 360) and the distribution centers (e.g., 350) each can include one or more computer systems.

In a number of embodiments, each of physical stores 360 can be a retail store, such as a department store, a grocery store, or a super store (e.g., both a grocery store and a department store). In many embodiments, the distribution centers (e.g., 350) can provide the items sold at the physical stores (e.g., 360). For example, a distribution center (e.g., 350) can supply and/or replenish stock at the physical stores (e.g., 360) that are in a region of the distribution center. In many embodiments, a physical store (e.g., 361-363) can submit an order to a distribution center (e.g., 350) to supply and/or replenish stock at the physical store (e.g., 361-363). In many embodiments, distribution center 350 can be referred to as a warehouse or other facility that does not sell products directly to a customer.

In some embodiments, route optimization system 300 can be a distributed system that includes one or more systems in each of the distribution centers (e.g., 350). In other embodiments, route optimization system 300 can be a centralized system that communicates with computer systems in the physical stores (e.g., 360) and distribution centers (e.g., 350). In some embodiments, network 330 can be an internal network that is not open to the public, which can be used for communications between route optimization system 300, physical stores (e.g., 360), and distribution centers (e.g., 350). In other embodiments, network 330 can be a public network, such as the Internet. In several embodiments, operators and/or administrators of route optimization system 300 can manage route optimization system 300, the processor(s) of route optimization system 300, and/or the memory storage unit(s) of route optimization system 300 using the input device(s) and/or display device(s) of route optimization system 300, or portions thereof in each case.

In several embodiments, route optimization system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to route optimization system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of route optimization system 300. In a similar manner, the processors and/or the non-transitory computer-readable media can be local and/or remote to each other.

Meanwhile, in many embodiments, route optimization system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between route optimization system 300, physical stores 360, distribution center 350, and/or the one or more databases can be implemented using any suitable manner of wired and/or wireless communication. Accordingly, route optimization system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In several embodiments, route optimization system 300 can receive an order for a physical store (e.g., 361-363) and can automatically design how the order will be fulfilled from a distribution center to delivery at the store. In a number of embodiments, route optimization system 300 can determine pallets to be used for items in the order, how to build stacks of the pallets to be shipped in trailers, designing and/or obtaining routes to be used for the trailers, and designing loads within the trailers for these routes. In several embodiments, route optimization system 300 can automatically design the type of trailer used for the route plan, where each type of trailer can be any form of road haulage shipping container or compartment, such as a semi-trailer, a full trailer, etc. Further, each type of trailer can include any form of temperature controlled trailer and/or compartments (e.g., bulkheads) for the designated loads transported by the designated type of trailer.

In many embodiments, route optimization system 300 can include a loading system 301, a route construction system 302, a pallet check system 303, a communication system 304, a feasibility check system 305, and/or an iterative system 306. In many embodiments, the systems of route optimization system 300 can be modules of computing instructions (e.g., software modules) stored at non-transitory computer readable media that operate on one or more processors. In other embodiments, the systems of route optimization system 300 can be implemented in hardware. Route optimization system 300 can be a computer system, such as computer system 100 (FIG. 1), as described above, and can be a single computer, a single server, or a cluster or collection of computers or servers, or a cloud of computers or servers. In another embodiment, a single computer system can host route optimization system 300. The dynamic optimization system can be similar or identical to the automatic generation of load and route design and activities shown and described in U.S. patent application Ser. No. 16/777,498, filed Jan. 30, 2020, (referred to herein as the “'498 Patent Application”), and the '498 Patent Application is incorporated herein by reference in its entirety. Additional details regarding route optimization system 300 and the components thereof are described herein.

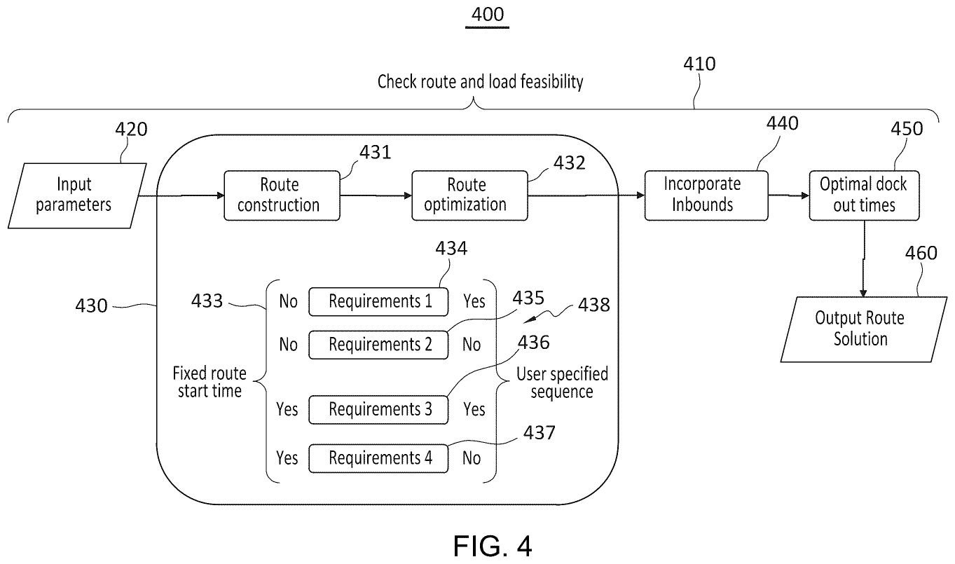

Jumping ahead in the drawings, FIG. 4 illustrates a flow chart for a method 400 of automatically integrating stop changes on the route plan to add and/or remove stops using a dynamic single route optimization system, according to an embodiment. Method 400 also can be used to conduct trailer loading feasibility checks based on the updated route plan. Method 400 further can include conducting load feasibility checks for each updated route plan checking whether a feasible load can be achieved based on the parameters of the stop change. Various activities associated with method 400 can be similar or identical to various activities in the '498 Patent Application. Method 400 can be employed in many different embodiments and/or examples not specifically depicted or described herein. In a number of embodiments, certain elements of method 400 can perform, involve, and/or be generated by various procedures, processes, and/or activities. In some embodiments, the procedures, the processes, and/or the activities of method 400 can be performed in the order presented or in parallel. In other embodiments, the procedures, the processes, and/or the activities of method 400 can be performed in any suitable order. In still other embodiments, one or more of the procedures, the processes, and/or the activities of method 400 can be combined or skipped. In several embodiments, route optimization system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as route optimization system 300. The processor(s) can be similar or identical to the processor(s) described above with respect to computer system 100 (FIG. 1).

In various embodiments, method 400 can be employed as an advantageous improvement over conventional manual approaches by addressing production needs for stop modifications (e.g., change requests) for a feasible route plan previously designed. In several embodiments, another advantage of using the route optimization system can include generating modifications to the route plan by adding or removing portions of the stopping locations along the route plan. In many embodiments, some advantages of the route optimization plan can include (1) an updated route plan with minimized travelling miles, (2) ensuring the updated trailer load is feasible given fixed parameters and user specified sequences, and (3) recommending optimal stop sequencing, route start times, and/or dock out times.

In several embodiments, method 400 can include a route and load feasibility framework 410 of checking whether or not each route and load violate any constraints. In some embodiments, route and load feasibility framework 410 also can output optimal dock out times as part of an updated route solution. In many embodiments, route and load feasibility framework 410 can include a block 420, 430, 440, 450, and 460.

In some embodiments, method 400 can include block 420 of receiving input parameters to construct a route plan to deliver orders to designated stops along the route plan. In several embodiments, input parameters can include store rules (e.g., delivery time windows), distribution center rules, pallets (e.g. dry or temperature controlled), sequential stops, hours of operation (HOS), trailer types (e.g., dry or temperature controlled), inbound loads (e.g., picking up loads), outbound loads (e.g., delivering loads), and/or another suitable type of parameter consistent with a route plan. In many embodiments, method 400 can proceed after block 420 to a block 430.

In various embodiments, method 400 can include block 430 of a single route optimization framework that can include a block 431, a block 432, and a block 438 to generate a single updated route as optimized by the change requests and/or stop requirements.

In several embodiments, method 400 can include block 431 of constructing a route plan based on input parameters. Various activities associated with block 431 can be similar or identical to various activities in the '498 Patent Application. In various embodiments, method 400 can proceed after block 431 to a block 432.

In some embodiments, method 400 can include block 432 of updating the route plan by incorporating various change request parameters. In many embodiments, block 432 can use the reconfigured data based on a scenario specification out of multiple scenario specifications. In various embodiments, method 400 can include a block 438 of determining which of one of multiple scenario specifications applies to an updated route plan based on flexible and/or fixed requirements from various respective change requests.

In various embodiments, the scenario specifications used in block 438 can be used by a main logic of the route optimization logic to address different scenarios for an updated route plan. In some embodiments, the different scenario specifications can include inquiring whether a respective combination of requirements in a change request are present before using the requirements as input in to the main logic section of the route optimization system. In various embodiments, each respective scenario specification can determine the type of scenario for this change request by: (i) whether a fixed route time is present and (ii) user specified sequences. In some embodiments, each scenario specification determines which parameters the route optimization system can be allowed to adjust or modify in order to generate an output of an updated route plan with an optimal dock out time, as recommended. In many embodiments, scenario specifications 433 include four different scenario specifications 434-437.

In a number of embodiments, each of scenario specifications 433 can specify whether or not the route includes a fixed route start time and/or and whether or not the route can have a user specified sequence. In various embodiments, scenario specification 434 can specify a respective scenario sequence with no fixed route start time and a user specified sequence. In some embodiments, scenario specification 435 can specify a respective scenario sequence with no fixed route start time and no user specified sequence. In several embodiments, scenario specification 436 can specify a respective scenario sequence with a fixed route start time and a user specified sequence. In many embodiments, scenario specification 437 can specify a respective scenario sequence with a fixed route start time and no user specified sequence.

In some embodiments, method 400 can include block 432 of generating an updated route plan by incorporating the data in a previous route and a respective requirement associated with each change request. In many embodiments, method 400 can proceed after block 432 to a block 440.

In various embodiments, method 400 can include block 440 of incorporating inbound routing into the updated route plan. In some embodiments, a change request can include adding a change stop to an updated route plan to incorporate an inbound stop based on the availability of an empty trailer returning to a distribution center. In many embodiments, method 400 can proceed after block 440 to a block 450.

In several embodiments, method 400 can include block 450 of determining optimal dock out times to recommend as part of the updated route plan. In many embodiments, method 400 can proceed after block 450 to a block 460.

In a number of embodiments, method 400 can include block 460 of outputting an updated route plan as a route solution addressing the change requests for the route plan. In various embodiments, block 460 also can output an optimized single route plan that can include modifications to: (i) a sequences of activities, (ii) a route start time, (iii) an outbound load, (iv) an inbound load, (v) an optimal dock out time, and/or (vi) a feasible load based on each change request.

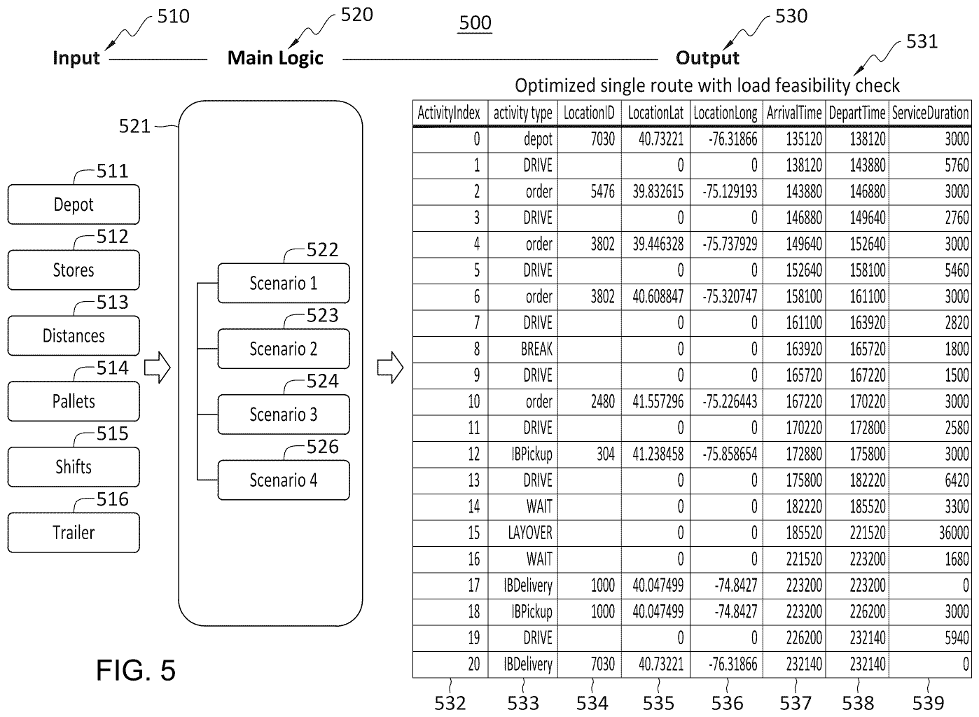

Turning ahead in the drawings, FIG. 5 illustrates a flow chart for a method 500 of generating an updated route plan based on each combination of input parameters and respective scenario specifications, according to an embodiment. Method 500 can be employed in many different embodiments and/or examples not specifically depicted or described herein. In some embodiments, the procedures, the processes, and/or the activities of method 500 can be performed in the order presented or in parallel. In other embodiments, the procedures, the processes, and/or the activities of method 500 can be performed in any suitable order. In still other embodiments, one or more of the procedures, the processes, and/or the activities of method 500 can be combined or skipped. In several embodiments, route optimization system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as route optimization system 300. The processor(s) can be similar or identical to the processor(s) described above with respect to computer system 100 (FIG. 1).

In various embodiments, method 500 can include a block 510 of receiving input data for a route plan with a change request. In many embodiments, the combinations of the input data and the respective scenario specification (e.g., scenario) can be used as input into the main logic of the route optimization system to generate the route plan and/or an updated route plan. In several embodiments, input parameters can include depot 511, stores 512, distances 513, pallets 514, driver shifts 515, trailer type 516, and/or another suitable parameter for a route plan. As an example, depot 511 can include a distribution center identified by a distribution center identifier and geographical locations, such as latitude and longitude. Similarly, stores 512 can include a store identifier, a geographical location, and a distribution source identifier. Further in this example, stores 512 can include a position rule to address a desired position for a store within the updated route plan. In following this example, the position for each store in the route plan also addresses accommodating a store time window range indicating available start times and stop times for accepting deliveries.

In many embodiments, distance 513 can include a distance matrix listing distances and times between stores and the distribution center in the route plan. In some embodiments, distance 513 can include multipliers for various factors, such as traffic patterns. Such an example of a distance matrix can be illustrated in Table 2, below.

TABLE 2
Distance matrix

| Frmndex | ToIndex | Miles | Seconds | DistanceMultiplier | TimeMultiplier |
|---|---|---|---|---|---|
| 7030 | 7030 | 0 | 0 | 1 | 1.05 |
| 7030 | S476 | 300 | 18000 | 1 | 1.05 |
| 7030 | 8302 | 300 | 660 | 1 | 1.05 |
| 7030 | 2480 | 10 | 660 | 1 | 1.05 |
| 7030 | 3802 | 300 | 660 | 1 | 1.05 |
| 5476 | 7030 | 300 | 660 | 1 | 1.05 |
| 5476 | 5476 | 0 | 0 | 1 | 1.05 |
| $476 | 8302 | 300 | 660 | 1 | 1.05 |
| $476 | 2480 | 300 | 660 | 1 | 1.05 |
| 5476 | 3802 | 10 | 18000 | 1 | 1.05 |
| 8302 | 7030 | 10 | 660 | 1 | 1.05 |
| 8302 | 5476 | 300 | 660 | 1 | 1.05 |
| 8302 | 8302 | 0 | 0 | 1 | 1.05 |
| 8302 | 2480 | 300 | 18000 | 1 | 1.05 |
| 8302 | 3802 | 300 | 660 | 1 | 1.05 |
| 2480 | 7030 | 300 | 18000 | 1 | 1.05 |
| 2480 | 5476 | 10 | 660 | 1 | 1.05 |
| 2480 | 8302 | 300 | 660 | 1 | 1.05 |
| 2480 | 2480 | 0 | 0 | 1 | 1.05 |
| 2480 | 3802 | 300 | 660 | 1 | 1.05 |
| 3802 | 7030 | 300 | 660 | 1 | 1.05 |
| 3802 | 5476 | 300 | 660 | 1 | 1.05 |
| 3802 | 8302 | 10 | 18000 | 1 | 1.05 |
| 3802 | 2480 | 300 | 660 | 1 | 1.05 |
| 3802 | 3802 | 0 | 0 | 1 | 1.05 |

In various embodiments, driver shifts 515 can include shift information of the trailer within a shift time window where each feasible route plan starts and returns within the shift time window. For example, each route plan starts with a dock out start time and a return time within a service duration time for each store. In several embodiments, trailer type 516 can include trailer type information including a trailer identifier, trailer dimensions, weight limitations of the trailer in total by axel, axel movement ranges, and bulkhead positions ranges. For example, bulkheads can be used to divide trailers with more than one temperature controlled zone. For example, a trailer type frozen, dairy, and deli (FDD) can have pallets that require temperatures from −20 degrees Fahrenheit for Frozen and 32-36 degrees Fahrenheit for dairy and deli. Bulkheads can create temperature-controlled zones within the trailer. A trailer can include up to two bulkheads where each bulkhead has a position range assigned to it. As another example, 636″ trailer with two bulkheads, starting from the nose to the tail of the trailer, bulkhead 1 min/max position range can be 88″/241″ and bulkhead 2 min/max position range 358″ to 442″. Since the pallet dimensions can be 48″×40″, this example can include two temperature-controlled zones and 1 bulkhead. In following this example, the zone to the nose of the trailer can be the frozen zone with −20 degrees Fahrenheit with 10 pallets (two pallets per row), then the bulkhead can be available for the temperature-controlled division. Additinoally, the remainder of trailer can then be assigned to pallets of dairy, and deli with 32-36 degrees Fahrenheit.

In some embodiments, block 510 can be similar or identical to block 420 (FIG. 4). In many embodiments, method 500 can proceed after block 510 to a block 520.

In a number of embodiments, method 500 can include block 520 of analyzing, using a main logic of the route optimization system, the combination of input data and respective scenario specifications. In many embodiments, a user specification sequence can include constraints that affect the outcome of adjusting a dock out time and/or a dock out time strategy. In several embodiments, block 520 can handle scenarios 521, such as scenarios 522, 523, 524, and 526, which correspond to scenario specifications 434-437, respectively. The term route optimizer system can be used interchangeably with the term optimizer.

In scenario 522 (Scenario 1, there is no fixed route start time, but there is a user specified sequence. An earliest route start time can be provided, in which the route start time can be modified as part of the feasible solution. Scenario 522 can apply to scenario specification 434, in which the user specified sequence begins with an original route start time that is flexible, as scenario 522 does not have a fixed route start time. In some embodiments, the optimizer (e.g., main logic) is allowed to modify (e.g., play with) the parameters of the route start time using a predetermined number of iterations until a feasible route solution out of many updated route solutions can be reached. In various embodiments, the optimizer can adjust outbound dock out time in order to attach an inbound load change request. As an example, after delivering the loads (e.g., store pallets), a trailer can include an inbound change request to pick up a load before returning to a distribution center. Such an example of an inbound change request can include a pickup start time and a pick up end time.

In several embodiments, in scenario 522 block 520 can determine an optimal dock out time based on the parameters of scenario 522. In many embodiments, block 520 can output a recommendation including an earliest and latest optimal dock out time for the updated route plan. In several embodiments, block 520 also can update a dock out time based on a dock out strategy.

In scenario 523 (Scenario 2), the optimizer can modify or play with multiple stop sequences and a flexible route plan to generate the optimal updated route plan out of several iterations of updated route plans. In various embodiments, unlike scenario 522, the optimizer can modify the route sequences in the route plan. In some embodiments, the optimizer can adjust an outbound dock out time to incorporate an inbound load change request. Similar to scenario 522, scenario 523 can involve providing a recommendation including an earliest and latest optimal dock out time for the updated route plan. In several embodiments, block 520 in scenario 523 also can update a dock out time without relying on a dock out strategy.

In scenario 524 (Scenario 3), the optimizer can validate a route plan based on user specified sequences with a fixed route start time. In several embodiments, optimizer is no longer allowed to modify the route start time as part of determining a feasible updated route solution. In various embodiments, scenario 524 can involve checking against earliest shift start times to recommend the earliest and latest optimal dock out times.

In scenario 526 (Scenario 4), the optimizer can be constrained by a fixed route start time where the optimizer determines a modified route plan using the fixed route start time. In some embodiments, unlike scenario 523, the optimizer can modify the dock out time. Similar to scenario 523, scenario 526 also can involve outputting a recommendation include an earliest and latest optimal dock out time for the updated route plan. In several embodiments, scenario 526 also can involve updating a dock out time without relying on a dock out strategy. In many embodiments, method 500 can proceed after block 520 to a block 530.

In several embodiments, method 500 can include block 530 of outputting an optimized single route with a load feasibility check. For example, block 530 can output an exemplary updated route plan 531 with exemplary activities of the optimized single route with load feasibility check. For example, exemplary updated route plan 531 can include activity index 532, activity type 533, location identifier 534, location latitude 535, location longitude 536, arrival time 537, departure time 538, and service duration 539 from an end to end route plan.

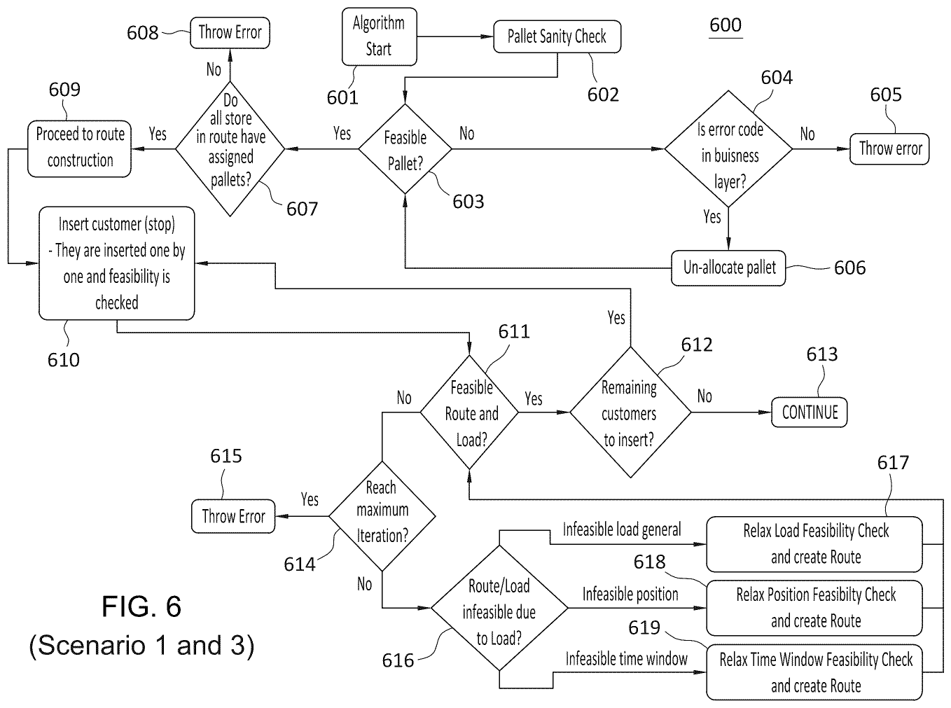

Turning ahead in the drawings, FIG. 6 illustrates a flow chart for a method 600 of constructing an updated route plan and load plan, according to an embodiment. The load feasibility check and the route feasibility check can be similar or identical to the enhanced load feasibility check and the route feasibility check activities shown and described in U.S. patent application Ser. No. 17/163,428, filed Jan. 30, 2021, (referred to herein as the “'428 Patent Application”), and the '428 Patent Application is incorporated herein by reference in its entirety. In some embodiments, method 600 can apply to scenario 522 and/or scenario 524 (FIG. 5).

Method 600 can be employed in many different embodiments and/or examples not specifically depicted or described herein. In some embodiments, the procedures, the processes, and/or the activities of method 600 can be performed in the order presented or in parallel. In other embodiments, the procedures, the processes, and/or the activities of method 600 can be performed in any suitable order. In still other embodiments, one or more of the procedures, the processes, and/or the activities of method 600 can be combined or skipped. In several embodiments, route optimization system 300 (FIG. 3) can be suitable to perform method 600 and/or one or more of the activities of method 600.

In a number of embodiments, method 600 can include a block 601 of starting the route optimization system (e.g., algorithm) to implement modifications for each updated route plan. Method 600 can proceed after block 601 to a block 602.

In several embodiments, method 600 can include block 602 of conducting a pallet check (e.g., a pallet sanity check) for each pallet loaded on the trailer after selecting the optimal updated route plan. In some embodiments, each pallet check test can be designed to address multiple loading violations to be corrected prior to the start of a designated route start time. In various embodiments, an example of input for pallets can include a pallet identifier, the distribution center (e.g., source of the load), a store destination, and/or another suitable pallet identifier. In some embodiments, input for pallets can include a number of cases within the pallet, stacking rules that apply to each pallet including where a pallet can be divided (e.g., distribute), distinguishing product types such as dairy and deli, frozen, and/or another product type, pallet characteristics such as a cube (volume), rules determining whether a pallet can be stored next to a bulkhead, and/or another pallet characteristic. In many embodiments, a feasibility check for pallet can include checking whether any violations exist for each pallet in a load simultaneously checked as part of the updated route plan.

In various embodiments, a pallet violation can include exceeding a maximum pallet weight in violation of standardized loading safety constraints. In some embodiments, another pallet violation can include exceeding a maximum cube weight in violation of standardized loading safety constraints. In many embodiments, another pallet violation can include a pallet with infeasible pallet dimensions in violation of standardized loading safety constraints. In several embodiments, another pallet violation can include a pallet with a conflicting commodity type of pallet for the trailer type. As an example, a temperature controlled pallet with refrigerated items can conflict with a dry trailer without temperature controlled bulkheads. In some embodiments, another pallet violation can include a pallet unlabeled or missing a source identifier. In several embodiments, another pallet violation can include a missing destination identifier. In many embodiments, another pallet violation can include a pallet that is an infeasible pallet that is part of a stacked group of pallets.

In several embodiments, another pallet violation can include a pallet that is an infeasible pallet beyond a temperature range for the items and/or the trailer type. In some embodiments, another pallet violation can include a pallet unlabeled or missing a product type identifier. In many embodiments, method 600 can proceed after block 602 to a block 603.

In various embodiments, method 600 can include a block 603 of determining whether or not each pallet of the pallets in the loading plan is a feasible pallet. In many embodiments, a feasible pallet can be counted as part of a feasible loading plan of an updated route plan or a route plan. If block 603 is yes, method 600 can proceed to block 607. Otherwise, block 603 is no, method 600 can proceed to block 604.

In several embodiments, method 600 can include block 604 of determining whether or not an error code exists in a business layer. If block 604 is yes, then method 600 can proceed to a block 606. Otherwise, block 604 is no, method 600 can proceed to a block 605 of throwing an error that can terminate the algorithm for block 604.

In some embodiments, method 600 can include block 606 of un-allocating the pallet and returning the unallocated pallet to block 603 for further processing. In many embodiments, method 600 can proceed after block 603 to a block 607.

In various embodiments, method 600 can include a block 607 of determining whether all stores in the route plan have assigned (e.g., allocated) pallets in the loading plan. If block 607 is yes, method 600 can proceed to a block 609. Otherwise, block 607 is no, method 600 can proceed to a block 608 of throwing an error that can terminate the algorithm for block 607.

In a number of embodiments, method 600 can include block 609 of proceeding to constructing an updated route plan. In many embodiments, method 600 can proceed after block 609 to a block 610.

In several embodiments, method 600 can include block 610 of inserting a stop change (e.g., a customer stop or change request) into the route plan to update the previous route plan. In some embodiments, each stop change is inserted one by one after each a feasibility check in conducted before inserting the next stop change. In many embodiments, method 600 can proceed after block 610 to a block 611.

In various embodiments, method 600 can include block 611 of determining whether or not a load and route, as updated, are feasible. In some embodiments, block 611 can include a trigger of when a load feasibility check is run based on one or more violations. In several embodiments, a route and load feasibility check can include multiple feasibility checks, such as described below in Table 1.

TABLE 1
Route and Load Feasibility Checks

| Type | Name | Descriptions |
|---|---|---|
| Route | Violate delivery | Cannot find a route which complies with |
| | time window | store delivery time window constraint |
| Load | Violate store | Cannot find a route which does not violate |
| | position rule | position rules specified for store. |
| | Violate backhaul | Cannot comply with time windows required |
| | time window | by backhaul |
| | Violate backhaul | Cannot pickup backhaul due to the un- |
| | trailer type match | matched trailer type |
| | Violate backhaul | Cannot pickup backhaul due to the shorter |
| | trailer length | trailer length |
| | Violate max | Invalid pallet weight for pallet: |
| | pallet weight | “palletID” |
| | Violate max | Invalid cube for pallet: “palletID” |
| | pallet cube | |
| | Violate pallet | Invalid pallet dimensions for pallet: |
| | dimensions | “palletID” |
| | Violate commodity | Cannot put temperature-controlled pallet |
| | type | in a dry trailer |
| | Violate load | Violate load feasibility |
| | feasibility | |

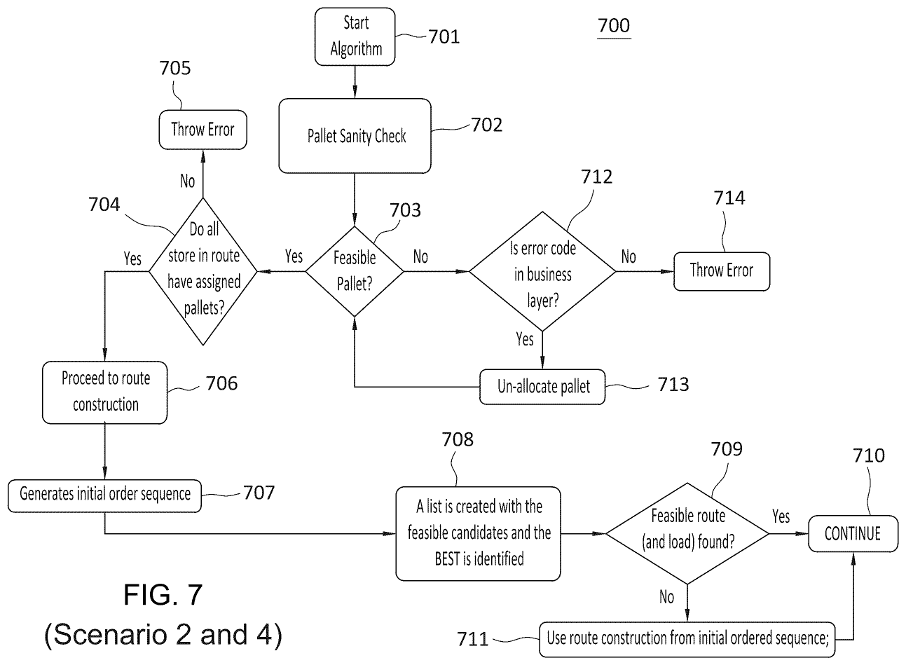

If block 611 is yes, method 600 can proceed to block 612. Otherwise block 611 is no, method 600 can proceed to a block 614. In many embodiments, block 611 can be similar or identical to the activities described below in block 709 (FIG. 7) and Table 1.

In several embodiments, method 600 can include block 612 of determining whether or not there are remaining stops (e.g., customer stops) to insert in to the route plan. If block 612 is yes, method 600 can return to block 610 for further processing. Otherwise block 612 is no, method 600 can proceed to block 613 of receiving an updated dock start time.

In some embodiments, method 600 can proceed to block 614 of determining whether or not the algorithm has reached a maximum iteration of a predetermined number of iterations. If block 614 is yes, method 600 can proceed to block 615 of throwing an error that can terminate the algorithm for block 614. Otherwise, block 614 is no, method 600 can proceed to a block 616.

In several embodiments, method 600 can include block 616 of determining whether or not a route or a load is infeasible due to an infeasible load. If block 616 is yes, method 600 can proceed to a block 617, a block 618, and a block 619. In many embodiments, block 616 can be similar or identical to the activities described below in block 709 (FIG. 7) and Table 1.

In various embodiments, method 600 can include block 617 of determining whether the load is infeasible due to a general violation during a load feasibility check. In some embodiments, block 617 the load feasibility check can include checks for stacking pallets, loading patterns (widthwise, pinwheeling, lengthwise), compartment feasibility (when bulkheads are used for stacks with different temperature requirements, such as frozen and refrigerated.) Additionally, the load feasibility checks also can include checking on load capacity such as checking against the weight of a trailer, cube, and maximum floor spot capacities, similar to the violations outlined in Table 1.

In many embodiments, block 617 can include relaxing the load feasibility check and to correct the violation and create a modified or updated route plan. In some embodiments, method 600 can proceed after block 617 to block 611.

In several embodiments, method 600 can include block 618 of determining whether the load is infeasible due to a position error in the floor of the trailer during the position feasibility check. In many embodiments, block 618 can check position errors of each store in sequence (position) in the route plan. For example, such a position check can include position rules, such as whether a store desires to be first or last on the route plan. In some embodiments, block 618 can relax the position feasibility check to correct the infeasible position error and create a modified or updated route plan. In some embodiments, method 600 can proceed after block 618 to block 611.

In various embodiments, method 600 can include block 619 of determining whether the load is infeasible due to an infeasible time window error found during a time window feasibility check. In several embodiments, block 619 also can include checking for a feasible update time by analyzing time windows for each store and depot considering distances travelled and travel times to complete each stop, similar to the distance matrices in Table 2. In some embodiments, block 619 can relax the time window feasibility check to correct the infeasible time window error and create a modified or updated route plan. In some embodiments, method 600 can proceed after block 619 to block 611.

Turning ahead in the drawings, FIG. 7 illustrates a flow chart for a method 700 of constructing an updated route plan incorporating each constraint of a respective user specified sequence, according to an embodiment. Various activities associated with method 700 can be similar or identical to various activities described in the '428 Patent Application. In some embodiments, method 700 can apply to scenario 523 and/or scenario 526 (FIG. 5).

Method 700 can be employed in many different embodiments and/or examples not specifically depicted or described herein. In some embodiments, the procedures, the processes, and/or the activities of method 700 can be performed in the order presented or in parallel. In other embodiments, the procedures, the processes, and/or the activities of method 700 can be performed in any suitable order. In still other embodiments, one or more of the procedures, the processes, and/or the activities of method 700 can be combined or skipped. In several embodiments, route optimization system 300 (FIG. 3) can be suitable to perform method 700 and/or one or more of the activities of method 700.

In some embodiments, method 700 can include a block 701 of starting the route optimization system (e.g., algorithm) to implement modifications for each updated route plan. Method 700 can proceed after block 701 to a block 702.

In various embodiments, method 700 can include block 702 of conducting a pallet check (e.g., a pallet sanity check) for each pallet loaded on the trailer after selecting the optimal updated route plan. In many embodiments, each pallet check test can be designed to address multiple loading violations to be corrected prior to the start of a designated route start time. In some embodiments, the pallet violations of block 702 can be similar or identical to the pallet violations above in connection with block 602 (FIG. 6). In many embodiments, method 700 can proceed after block 702 to a block 703.

In some embodiments, the pallet check, can reduce errors within several properties of the pallets. As an example, the following checks can be performed iteratively on the pallets one by one, as follows:
pallet dimensions. If the dimensions of the pallets are different than the expected ones, the sanity check is not passed, and the pallet can be unallocated.
max pallet weight exceeded. If it exceeds the maximum weight, the pallet can be unallocated.
max pallet cube exceeded. If it exceeds the maximum cube, the pallet can be unallocated.
conflicting commodity type. The pallet commodity type is checked against the trailer type, for example, a frozen perishable pallet cannot be allocated in a DRY trailer type. If such pallet is detected, it can be can be unallocated.
No source ID. If the pallet does not have a distribution center identification.
No destination ID. If the pallet does not have a store identification.
Infeasible pallet stack group. Each pallet has a stack group, i.e., “ANY”, “BOTTOM”, “CHECMICAL”, “INTACT”, “NORMAL”, “SELF_STACK”, and/or “TOP”. A pallet check can determine whether or not the stack group is feasible.
Infeasible temperature pallet range. Pallet temperature range can be outside of the expected ranges.
No product type. The pallet has no product type, for example, frozen (F), dairy/deli (DD), produce (P).

In several embodiments, method 700 can include block 703 of determining whether or not a pallet is feasible. If block 703 is yes, method 700 can proceed to a block 704. Otherwise, block 703 is no, method 700 can proceed to a block 712. In many embodiments, block 712 can be similar or identical to the activities described in block 604 (FIG. 6).

In various embodiments, method 700 can include block 712 of determining whether or not an error code exists in a business layer. If block 712 is yes, then method 700 can proceed to a block 713. Otherwise, block 712 is no, method 700 can proceed to a block 714 of throwing an error that can terminate the algorithm for block 712. In many embodiments, block 714 can be similar or identical to the activities described in block 605 (FIG. 6).

In some embodiments, method 700 can include block 713 of un-allocating the pallet and returning the unallocated pallet to block 703 for further processing. In many embodiments, method 700 can proceed after block 713 to a block 703. In many embodiments, block 713 can be similar or identical to the activities described in block 606 (FIG. 6).

In several embodiments, method 700 can include block 704 of proceeding to constructing a route plan or an updated route plan. In many embodiments, method 700 can proceed after block 706 to a 707. In many embodiments, block 704 can be similar or identical to the activities described in block 609 (FIG. 6).

In various embodiments, method 700 can include block 707 of generating an initial order sequence as part of constructing the updated route plan. In several embodiments, the order sequence can be based on a distance from a closest distance to a farther distance from start location, such as a from a distribution center. In various embodiments, a base sequence can include the start location in the order sequence based on a main logic of the route optimization logic (route optimization system) that can address different scenario specifications for an updated route plan. In several embodiments, constructing iterations can include sorting out orders from stores and/or other entities by inserting each store order one by one into the version of the updated route plan. In several embodiments, constructing the updated route can include constructing iterations (e.g., permutations) into a version of an updated route where the route plan and load plan can be checked for violations and/or feasibility as each store order is inserted into the updated route plan. In some embodiments, checking whether or not to run a load feasibility check can be dependent on the updated route iteration. In many embodiments, block 707 can be similar or identical to the activities described in connection with blocks 614, 615, and 616 (FIG. 6). In some embodiments, method 700 can proceed after block 707 to a block 708.

In several embodiments, method 700 can include block 708 of generating a top list of feasible candidate updated route plans. In some embodiments, block 708 also can identify a top one of the feasible candidate updated route plans. In many embodiments, method 700 can proceed after block 708 to a block 709.

In a number of embodiments, method 700 can include block 709 of determining whether or not an updated route and updated load plan for the route is a feasible route plan. If block 709 is yes, method 700 can proceed to a block 710. Otherwise, block 709 is no, method 700 can proceed to a block 711. In many embodiments, block 709 can be similar or identical to the activities described in block 611 (FIG. 6).

In various embodiments, method 700 can include block 711 of using another route plan constructed from the initial ordered sequence of stops different from the previous infeasible route plan. In several embodiments, method 700 can proceed after block 711 to block 710 of receiving an updated dock start time. In many embodiments, block 710 can be similar or identical to the activities described in connect with block 613 (FIG. 6).

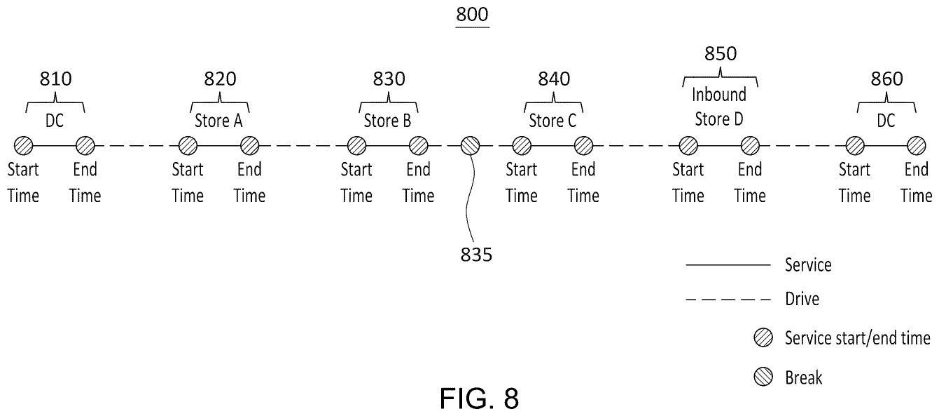

Jumping forward in the drawings, FIG. 8 illustrates a timeline 800 showing how a sequence of activities is created comprising multiple stop sequences in a single route plan. Timeline 800 shows time periods for a stop sequence, includes a start service time and stop service time.

Timeline 800 can begin at a distribution center 810 and end at with a distribution 860, where distribution 860 can include returning to the original distribution center 810 or another distribution center located in another location depending on the route plan parameters. In several embodiments, the exemplary single route plan can include several stops in-between a start and end points, such as Store A 820, Store B 830, Store C 840, Store D 850, and/or another set of multiple stores based on the parameters of the single route plan. In such an example, each store can be an outbound stop (e.g., delivering loads) and/or an inbound stop (e.g., picking up loads). In many embodiments, each single route plan can incorporate one or more driver break times based on HOS rules and other driver time constraints based on various U.S. Transportation regulations and restrictions. In timeline 800, the lines connecting the start time and end time indicated a service start and end time for that store. The timeline connects each distribution center and a store or a store to another store, and/or a store to a break 835, indicated a drive time between stops.

Timeline 800 incorporates a change request for a route plan by removing and/or adding an outbound route for another store and/or an inbound route for another store. As an example, a change request can include replacing store B 830 for a new Store E (not shown). As another example, a change request also can include switching a stop in the original sequence of stops, such as moving the stop at Store C 840 with the stop at Store A 820, or moving a stop at a Store to another sequence stop in the route plan. In following the examples, updating the route plan to incorporate these exemplary change requests affected: (i) the optimal dock out time to adjust for another outbound or inbound sequence, (ii) given a fixed route start time, the optimal stop sequence, (iii) the loading plan for the route plan, (iv) driving time, (v) driver break time, (vi) store delivery time windows to adjust service start and service end times for each store, and/or another suitable activity stop time in the route plan.

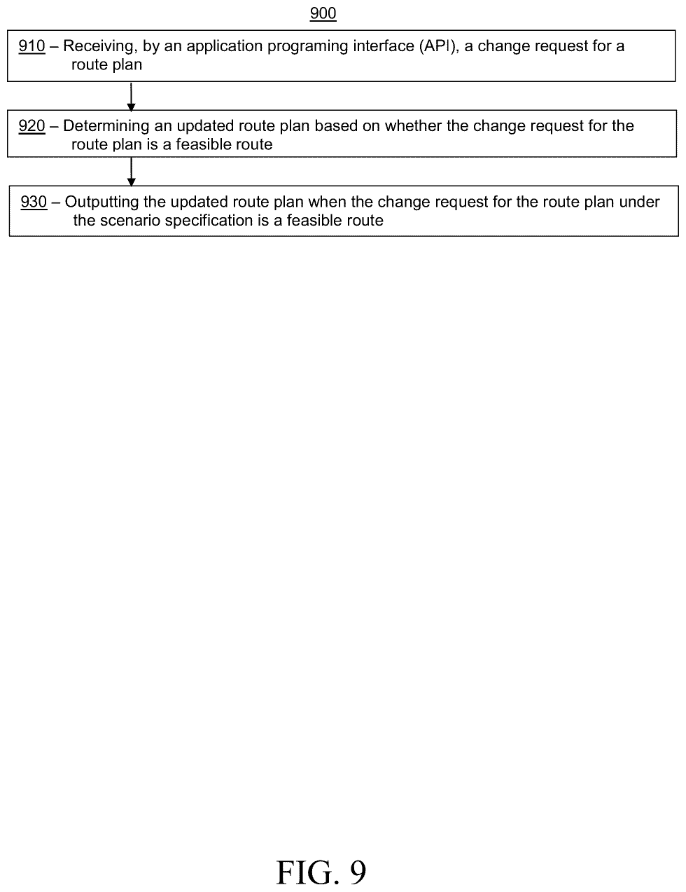

Turning ahead in the drawings, FIG. 9 illustrates a flow chart for a method 900 of automatically generating an updated route plan based on a change request to the previous route plan, according to another embodiment. In many embodiments, method 900 also can be employed for determining whether or not the updated route plan is a feasible route and outputting a route start time based on the updated route plan. Method 900 is merely exemplary and is not limited to the embodiments presented herein. Method 900 can be employed in many different embodiments and/or examples not specifically depicted or described herein. In some embodiments, the procedures, the processes, and/or the activities of method 900 can be performed in the order presented. In other embodiments, the procedures, the processes, and/or the activities of method 900 can be performed in any suitable order. In still other embodiments, one or more of the procedures, the processes, and/or the activities of method 900 can be combined or skipped. In several embodiments, route optimization system 300 (FIG. 3) can be suitable to perform method 900 and/or one or more of the activities of method 900.

In these or other embodiments, one or more of the activities of method 900 can be implemented as one or more computing instructions configured to run at one or more processors and configured to be stored at one or more non-transitory computer-readable media. Such non-transitory computer-readable media can be part of a computer system such as route optimization system 300. The processor(s) can be similar or identical to the processor(s) described above with respect to computer system 100 (FIG. 1).

Referring to FIG. 9, method 900 can include a block 910 receiving, by an application programing interface (API), a change request for a route plan. In a number of embodiments, integration of an API into route planner system is advantageous to improve a previous route plan seamlessly incorporating change requests (e.g., stop changes) and subsequent feasibility checks as a practical application to the field of route and load planning approached. As an example, test results illustrate that given 100 stores with 2,000 pallets, load planner APIs can implement codes to CreateRoute and CreateLoad and identify an optimal solution within 68 routes. In many embodiments, block 910 can be implemented as described above in connection with blocks block 601 (FIG. 6) and/or block 701 (FIG. 7).

In various embodiments, the route plan can include one or more constraints. In some embodiments, the change request can be subject to a scenario specification and a load feasibility specification. In various embodiments, the change request for the route plan further comprises one or more stop change requests.

In several embodiments, the scenario specification can indicate (i) whether a route start time is fixed or flexible, and (ii) whether a sequence of stops is fixed or flexible. In some embodiments, the scenario specification specifies that the sequence of stops is fixed and the route start time is flexible. In various embodiments, the scenario specification specifies that both the sequence of stops and the route start time are flexible. In several embodiments, the scenario specification specifies that both the sequence of stops and the route start time that are fixed. In a number of embodiments, the scenario specification specifies that the route start time is fixed and the sequence of stops is flexible. In various embodiments, the change request for the route plan further comprises one or more stop change requests. In some embodiments, method 900 can proceed after block 910 to a block 920.

In several embodiments, method 900 also can include block 920 of determining an updated route plan based on whether the change request for the route plan is a feasible route based on the scenario specification and the load feasibility specification, and the route stop time is the route start time is flexible. In many embodiments, block 920 can be implemented as describe above in connection with block 438 (FIG. 4), block 520 (FIG. 5), blocks 611-613 (FIG. 6) and/or blocks 709-710 (FIG. 7).

In a number of embodiments, when the change request for the route plan is not a feasible route, iterating through relaxed feasibility constraints to determine the updated route plan that is a feasible route. In some embodiments, block 920 can include running a predetermined number of iterations until a maximum number of iterations are met.

In various embodiments, block 920 also can include conducting a pallet check for each pallet allocated based on the load feasibility specification for violations of constraints, identification errors, and violating temperature ranges. In some embodiments, block 920 further can include constructing the updated route plan based on the change request.

In several embodiments, block 920 of conducting the pallet check for each pallet can include determining whether each pallet violates the constraints, wherein the constraints comprises at least one of a maximum pallet weight or a maximum cube weight.

In some embodiments, block 920 of conducting the pallet check for each pallet also can include rejecting each pallet with infeasible pallet dimensions.

In several embodiment, block 920 of conducting the pallet check for each pallet additionally can include identifying conflicts between commodity types.

In many embodiments, block 920 of conducting the pallet check for each pallet further can include identifying each pallet with no source identification, no destination identification, or no product type.

In various embodiments, block 920 of conducting the pallet check for each pallet also can include identifying whether each pallet in a pallet stack group is infeasible.

In several embodiments, block 920 of conducting the pallet check for each pallet also can include identifying whether a temperature pallet range is infeasible.

In various embodiments, block 920 of conducting the pallet check for each pallet also can include unallocating a pallet after a violation is detected. In many embodiments, block 920 can be implemented as describe above in connection with block 606 (FIG. 6) and block 713 (FIG. 7).

In several embodiments, block 920 of conducting the pallet check for each pallet also can include upon unallocating the pallet, conducting another iteration of the pallet check as part of a feedback loop until the pallet is feasible. In many embodiments, block 920 can be implemented as describe above in connection with block 606 (FIG. 6) and block 713 (FIG. 7). In various embodiments, method 900 can proceed after block 920 to a block 930.

In some embodiments, method 900 further can include block 930 of outputting the updated route plan when the change request for the route plan under the scenario specification is a feasible route, and when the route stop time is flexible, outputting the route start time. In many embodiments, block 930 can be implemented as describe above in connection with block 460 (FIG. 4), block 530 (FIG. 5), block 613 (FIG. 6) and block 710 (FIG. 7).

Returning to FIG. 3, in many embodiments, loading system 301 can at least partially perform block 603 (FIG. 6) of determining whether or not each pallet of the pallets in the loading plan is a feasible pallet, block 607 (FIG. 6) of determining whether all stores in the route plan have assigned (e.g., allocated) pallets in the loading plan, block 608 (FIG. 8) of throwing an error that can terminate the algorithm for block 607, and/or block 709 (FIG. 7) of determining whether or not an updated route and updated load plan for the route is a feasible route plan.

In some embodiments, route construction system 302 can at least partially perform block 420 (FIG. 4) of receiving input parameters to construct a route plan to deliver orders to designated stops along the route plan, block 431 (FIG. 4) of constructing a route plan based on input parameters, block 432 of updating the route plan by incorporating various change request parameters, block 432 (FIG. 4) of generating an updated route plan by incorporating the data in a previous route and a respective requirement associated with each change request, block 440 (FIG. 4) of incorporating inbound routing into the updated route plan, block 450 (FIG. 4) of determining optimal dock out times to recommend as part of the updated route plan. In some embodiments, block 460 (FIG. 4) of outputting an updated route plan as a route solution addressing the change requests for the route plan, block 530 (FIG. 5) of outputting an optimized single route with a load feasibility check, block 601 (FIG. 6) of starting the route optimization system (e.g., algorithm) to implement modifications for each updated route plan, block 609 (FIG. 6) of proceeding to constructing an updated route plan, block 610 (FIG. 6) of inserting a stop change (e.g., a customer stop or change request) into the route plan to update the previous route plan, block 612 (FIG. 6) of determining whether or not there are remaining stops (e.g., customer stops) to insert in to the route plan, block 701 (FIG. 7) of starting the route optimization system (e.g., algorithm) to implement modifications for each updated route plan, block 704 (FIG. 7) of proceeding to constructing a route plan or an updated route plan, block 707 (FIG. 7) of generating an initial order sequence as part of constructing the updated route plan, and/or block 711 (FIG. 7) of using another route plan constructed from the initial ordered sequence of stops different from the previous infeasible route plan.

In several embodiments, pallet check system 303 can at least partially perform block 602 (FIG. 6) of conducting a pallet check (e.g., a pallet sanity check) for each pallet loaded on the trailer after selecting the optimal updated route plan, block 603 (FIG. 6) of determining whether or not each pallet of the pallets in the loading plan is a feasible pallet, block 604 (FIG. 6) of determining whether or not an error code exists in a business layer, block 605 (FIG. 6) of throwing an error that can terminate the algorithm for block 604, block 606 (FIG. 6) of un-allocating the pallet and returning the unallocated pallet to block 603 for further processing, block 702 (FIG. 7) of conducting a pallet check (e.g., a pallet sanity check) for each pallet loaded on the trailer after selecting the optimal updated route plan. In many embodiments, block 703 (FIG. 7) of determining whether or not a pallet is feasible, block 712 (FIG. 7) of determining whether or not an error code exists in a business layer, block 714 (FIG. 7) of throwing an error that can terminate the algorithm for block 712, and/or block 713 (FIG. 7) of un-allocating the pallet and returning the unallocated pallet to block 703 for further processing.

In various embodiments, communication system 304 can at least partially perform block 510 (FIG. 5) of receiving input data for a route plan with a change request, block 613 (FIG. 6) of receiving an updated dock start time, and/or block 710 (FIG. 7) of receiving an updated dock start time.

In a number of embodiments, feasibility check system 305 can at least partially perform block route and load feasibility framework 410 (FIG. 4) also can output optimal dock out times as part of an updated route solution, block 611 (FIG. 6) of determining whether or not a load and route, as updated, are feasible, block 616 (FIG. 6) of determining whether or not a route or a load is infeasible due to an infeasible load, block 617 (FIG. 6) of determining whether the load is infeasible due to a general violation during a load feasibility check, block 618 (FIG. 6) of determining whether the load is infeasible due to a position error in the floor of the trailer during the position feasibility check, and/or block 619 (FIG. 6) of determining whether the load is infeasible due to an infeasible time window error found during a time window feasibility check.

In a number of embodiments, iterative system 306 can at least partially perform block 520 (FIG. 5) of analyzing, using a main logic of the route optimization system, each unique combination of input data and respective scenario specifications, block 614 (FIG. 6) of determining whether or not the algorithm has reached a maximum iteration of a predetermined number of iterations, block 615 (FIG. 6) of throwing an error that can terminate the algorithm for block 614, and/or block 708 (FIG. 7) of generating a top list of feasible candidate updated route plans.

In many embodiments, the techniques described herein can be used continuously at a scale that cannot be handled using manual techniques. For example, the number of daily route and load plans can exceed approximately a million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as determining whether to update a route plan to incorporate stop changes within a shift time window based on change requests does not exist outside the realm of computer networks. Moreover, the techniques described herein can solve a technical problem that cannot be solved outside the context of computer networks.

In some embodiments, dynamically optimizing a single route and check load feasibility platform can address stop sequence modifications while minimizing travelling miles in an updated route plan while ensuring a load for trailer is feasible given the optimizable and/or fixed time requirements such as stop sequencing, route start time and/or a dock out start time.

In various embodiments, another advantage of using the dynamic single route optimization and trailer loading feasibility check platform (e.g., route optimization system 300 (FIG. 3)) can be a fast response time of less than 430 milliseconds to customize a solution with flexible or fixed dock out start times and using relaxed solutions that addresses route and/or load infeasibilities.

Various embodiments can include a system can include one or more processors and one or more non-transitory computer-readable media storing computing instructions, that when executed on the one or more processors, cause the one or more processors, to perform certain acts. The acts can include receiving, by an application programing interface (API), a change request for a route plan. The route plan can include one or more constraints. The change request can be subject to a scenario specification and a load feasibility specification. The scenario specification can indicates (i) whether a route start time is fixed or flexible, and (ii) whether a sequence of stops is fixed or flexible. The acts also can include determining an updated route plan based on whether the change request for the route plan is a feasible route based on the scenario specification and the load feasibility specification. The route stop time can be the route start time is flexible. The acts further can include outputting the updated route plan when the change request for the route plan under the scenario specification is a feasible route. The updated route plan further can include e when the route stop time is flexible, outputting the route start time.

A number of embodiments can include a method being implemented via execution of computing instructions configured to run at one or more processors and stored at one or more non-transitory computer-readable media. The method can include receiving, by an application programing interface (API), a change request for a route plan. The route plan can include one or more constraints. The change request can be subject to a scenario specification and a load feasibility specification. The scenario specification can indicates (i) whether a route start time is fixed or flexible, and (ii) whether a sequence of stops is fixed or flexible. The method also can include determining an updated route plan based on whether the change request for the route plan is a feasible route based on the scenario specification and the load feasibility specification. The route stop time can be the route start time is flexible. The method further can include outputting the updated route plan when the change request for the route plan under the scenario specification is a feasible route. The updated route plan further can include e when the route stop time is flexible, outputting the route start time

Although dynamically optimizing a single route plan and checking for load feasibility has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 3-9 may include different procedures, processes, and/or activities and be performed by many different modules, in many different orders, and/or one or more of the procedures, processes, or activities of FIGS. 3-7, 9 may include one or more of the procedures, processes, or activities of another different one of FIGS. 3-7, 9. As another example, the systems within route optimization system 300, loading system 301, route construction system 302, pallet check system 303, communication system 304, feasibility check system 305 and/or iterative system 306, (see FIGS. 3 and 8) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions, that when executed on the one or more processors, cause the one or more processors, to perform functions comprising:
receiving, by an application programing interface (API), a change request for a route plan, wherein the route plan comprises one or more constraints, wherein the change request is subject to a scenario specification and a load feasibility specification, wherein the scenario specification indicates (i) whether a route start time is fixed or flexible, and (ii) whether a sequence of stops is fixed or flexible;
determining an updated route plan based on whether the change request for the route plan is a feasible route based on the scenario specification and the load feasibility specification, and the route stop time is the route start time is flexible; and
outputting the updated route plan when the change request for the route plan under the scenario specification is a feasible route, and, when the route stop time is flexible, outputting the route start time.

2. The system of claim 1, wherein the change request for the route plan further comprises one or more stop change requests.

3. The system of claim 1, wherein the scenario specification specifies that the sequence of stops is fixed and the route start time is flexible.

4. The system of claim 1, wherein the scenario specification specifies that both the sequence of stops and the route start time are flexible.

5. The system of claim 1, wherein the scenario specification specifies that both the sequence of stops and the route start time that are fixed.

6. The system of claim 1, wherein the scenario specification specifies that the route start time is fixed and the sequence of stops is flexible.

7. The system of claim 1, wherein determining the updated route plan comprises:
when the change request for the route plan is not a feasible route, iterating through relaxed feasibility constraints to determine the updated route plan that is a feasible route; and
running a predetermined number of iterations until a maximum number of iterations are met.

8. The system of claim 1, wherein determining the updated route plan comprises:
conducting a pallet check for each pallet allocated based on the load feasibility specification for violations of constraints, identification errors, and violating temperature ranges; and
constructing the updated route plan based on the change request.

9. The system of claim 8, wherein conducting the pallet check comprises:
determining whether each pallet violates the constraints, wherein the constraints comprises at least one of a maximum pallet weight or a maximum cube weight;
rejecting each pallet with infeasible pallet dimensions;
identifying conflicts between commodity types;
identifying each pallet with no source identification, no destination identification, or no product type;
identifying whether each pallet in a pallet stack group is infeasible; and
identifying whether a temperature pallet range is infeasible.

10. The system of claim 9, wherein conducting the pallet check further comprises:
unallocating a pallet after a violation is detected; and
upon unallocating the pallet, conducting another iteration of the pallet check as part of a feedback loop until the pallet is feasible.

11. A method being implemented via execution of computing instruction configured to run on one or more processors and stored at one or more non-transitory computer-readable media, the method comprising: receiving, by an application programing interface (API), a change request for a route plan, wherein the route plan comprises one or more constraints, wherein the change request is subject to a scenario specification and a load feasibility specification, wherein the scenario specification indicates (i) whether a route start time is fixed or flexible, and (ii) whether a sequence of stops is fixed or flexible;
determining an updated route plan based on whether the change request for the route plan is a feasible route based on the scenario specification and the load feasibility specification, and the route stop time is the route start time is flexible; and
outputting the updated route plan when the change request for the route plan under the scenario specification is a feasible route, and, when the route stop time is flexible, outputting the route start time.

12. The method of claim 11, wherein the change request for the route plan further comprises one or more stop change requests.

13. The method of claim 11, wherein the scenario specification specifies that the sequence of stops is fixed and the route start time is flexible.

14. The method of claim 11, wherein the scenario specification specifies that both the sequence of stops and the route start time are flexible.

15. The method of claim 11, wherein the scenario specification specifies that both the sequence of stops and the route start time that are fixed.

16. The method of claim 11, wherein the scenario specification specifies that the route start time is fixed and the sequence of stops is flexible.

17. The method of claim 11, wherein determining the updated route plan comprises:
when the change request for the route plan is not a feasible route, iterating through relaxed feasibility constraints to determine the updated route plan that is a feasible route; and
running a predetermined number of iterations until a maximum number of iterations are met.

18. The method of claim 11, wherein determining the updated route plan comprises:
conducting a pallet check for each pallet allocated based on the load feasibility specification for violations of constraints, identification errors, and violating temperature ranges; and
constructing the updated route plan based on the change request.

19. The method of claim 18, wherein conducting the pallet check comprises:
determining whether each pallet violates the constraints, wherein the constraints comprises at least one of a maximum pallet weight or a maximum cube weight;
rejecting each pallet with infeasible pallet dimensions;
identifying conflicts between commodity types;
identifying each pallet with no source identification, no destination identification, or no product type;
identifying whether each pallet in a pallet stack group is infeasible; and
identifying whether a temperature pallet range is infeasible.

20. The method of claim 19, wherein conducting the pallet check further comprises:
unallocating a pallet after a violation is detected; and
upon unallocating the pallet, conducting another iteration of the pallet check as part of a feedback loop until the pallet is feasible.
